(19) United States
(12) Patent Application Publication
(10) Pub. No.: US 2025/0049261 A1
(43) Pub. Date: Feb. 13, 2025

(54) INDOOR GRILLING APPLIANCE WITH FLAVOR-INFUSION MODULE

(71) Applicant: Hamilton Beach Brands, Inc., Glen Allen, VA (US)

(72) Inventor: Chad Majewski, Glen Allen, VA (US)

(21) Appl. No.: 18/231,149

(22) Filed: Aug. 7, 2023

(51) Int. Cl. A47J 37/07; A23B 4/052; F24C 7/08; F24C 15/32

(52) U.S. Cl. CPC A47J 37/0786; A23B 4/052; A47J 37/0709; A47J 37/0754; A47J 37/0763; F24C 7/082; F24C 15/322; A47J 2037/0795; A47J 2202/00

(57) ABSTRACT

A grilling appliance includes: a lower housing including a cooking surface; a lid overlying and spaced from the cooking surface to define a cooking cavity; a heating element positioned to heat the cooking surface; a power source operatively connected with the heating element; and a flavor-infusion module attached to at least one of the lower housing and the lid. The flavor-infusion module comprises: a smoke generation chamber; and a flavor-infusion conduit fluidly connected between the smoke generation chamber and the cooking cavity.

### FIELD OF THE INVENTION

The present invention is related to indoor grills, and more particularly to indoor grills having flavor-infusion capability.

### BACKGROUND

Grilling is a preferred means of preparing many different foods. Grilling allows that to drip away from the food before it is consumed, resulting in healthier, lower fat food. Grilling also improves the flavor of many foods. The “grill marks” produced where the food contacts the rack of the grill is the result of “caramelization,” or the browning of the sugars within the food, which improves the flavoring of the food. Additionally, the food may absorb various flavors from the smoke produced within the grilling process.

Grilling is typically performed outdoors, where charcoal or propane are burned to produce the necessary heat. Depending on the temperature and/or any precipitation, outdoor cooking may not always be desirable. There are a number of available indoor grilling appliances (“grills”), which are typically one of two types: “clamshell”-style grills, which have both upper and lower heated surfaces that contact the food during cooking, and single-surface grills, which typically include a lower heating surface that contacts the food and a cover that overlies but is spaced apart from the lower surface and the food to form a cooking cavity. Clamshell-style grills may cook food more quickly, and do not require turning the food over during cooking to produce grill marks on both sides of the food, but may be more difficult to use with thicker foods and may produce more smoke to the environment. Single-surface grills typically produce less environmental smoke and can more easily handle foods of different thicknesses, but require turning of the food and typically cook more slowly.

It may be desirable to provide an indoor grill with additional capabilities.

### SUMMARY

As a first aspect, embodiments of the invention are directed to a grilling appliance comprising: a lower housing including a cooking surface; a lid overlying and spaced from the cooking surface to define a cooking cavity; a heating element positioned to heat the cooking surface; a power source operatively connected with the heating element; and a flavor-infusion module attached to at least one of the lower housing and the lid. The flavor-infusion module comprises: a smoke generation chamber; and a flavor-infusion conduit fluidly connected between the smoke generation chamber and the cooking cavity.

As a second aspect, embodiments of the invention are directed to a grilling appliance comprising: a lower housing including a cooking surface; a lid overlying and spaced from the cooking surface to define a cooking cavity; a heating element positioned to heat the cooking surface; a power source operatively connected with the heating element; and a flavor-infusion module attached to at least one of the lower housing and the lid. The flavor-infusion module comprises: a smoke generation chamber; a blower chamber fluidly connected with the smoke generation chamber; a flavor-infusion conduit fluidly connected between the blower chamber and the cooking cavity; and a fan positioned in the blower chamber and in fluid communication with the smoke generation chamber and the flavor-infusion conduit.

As a third aspect, embodiments of the invention are directed to a grilling appliance comprising: a lower housing including a cooking surface, the cooking surface having a plurality of upwardly-extending ribs; a lid overlying and spaced from the cooking surface to define a cooking cavity; a heating element positioned to heat the cooking surface; a power source operatively connected with the heating element; and a flavor-infusion module attached to at least one of the lower housing and the lid, the flavor-infusion module comprising: a smoke generation chamber; and a flavor-infusion conduit fluidly connected between the smoke generation chamber and the cooking cavity. The grilling appliance further comprises an infusion rack positioned within the cooking cavity, the infusion rack being configured to take a raised position above the ribs of the cooking surface so that food resting on the infusion rack is located above and not in contact with the cooking surface during infusion, the infusion rack being further configured to move to a lowered position in the cooking cavity, such that food positioned above the infusion rack is in contact with the ribs of the cooking surface and not in contact with the infusion rack.

### BRIEF DESCRIPTION OF THE FIGURES

FIG. 1 is a front perspective view of a flavor-infusing indoor grill according to embodiments of the invention.

FIG. 2 is a rear perspective view of the grill of FIG. 1.

FIG. 3 is a front perspective view of the grill of FIG. 1 with the lid removed and the infusion rack in a raised position above the cooking surface.

FIG. 4 is a top perspective view of the grill as in FIG. 3 with the infusion rack removed.

FIG. 5A is a top view of the grill as in FIG. 4.

FIG. 5B is a front perspective view of the cooking surface and infusion rack of the grill of FIG. 1 with the infusion rack in a lowered position.

FIG. 6 is a front section view of the grill of FIG. 1 with the infusion rack in the raised position.

FIG. 7 is an enlarged partial front section view of the infusion module of the grill of FIG. 1.

FIG. 8 is a top partial perspective view of the infusion module of FIG. 7 with the cover removed.

FIG. 9 is a front perspective view of the grill of FIG. 1 illustrating the lighting of flavoring fragments in the infusion module.

FIG. 10 is an enlarged quarter-section view of the housing of the infusion module of FIG. 7.

FIG. 11 is a partial front perspective section view of the infusion module of FIG. 7 illustrating the fan, motor and infusion conduit.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

It will also be understood that, as used herein, the terms “example,” “exemplary,” and derivatives thereof are intended to refer to non-limiting examples and/or variants embodiments discussed herein, and are not intended to indicate preference for one or more embodiments discussed herein compared to one or more other embodiments.

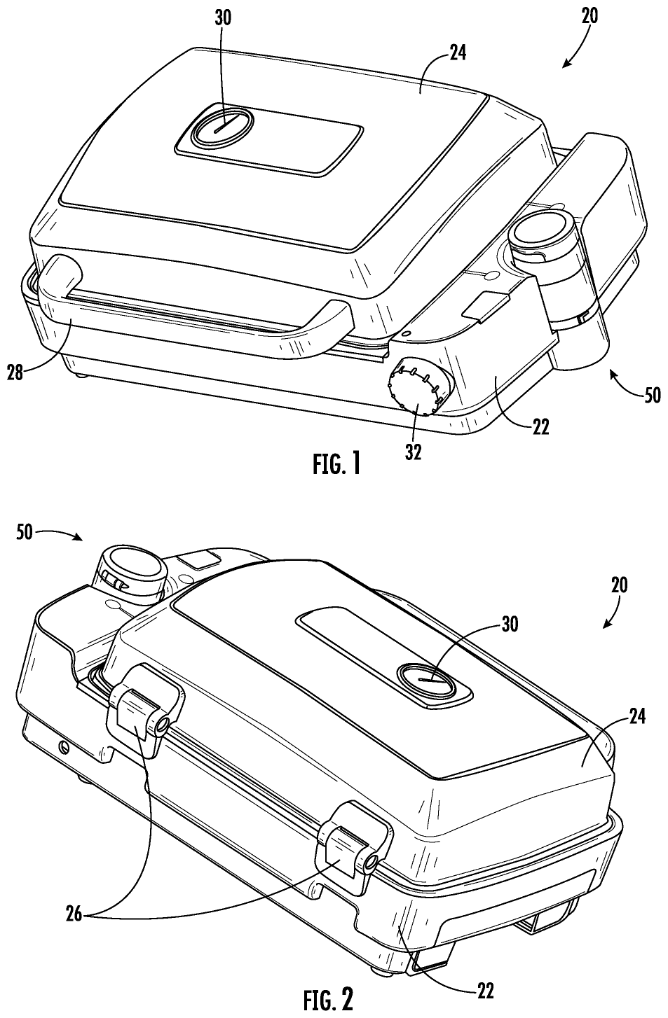

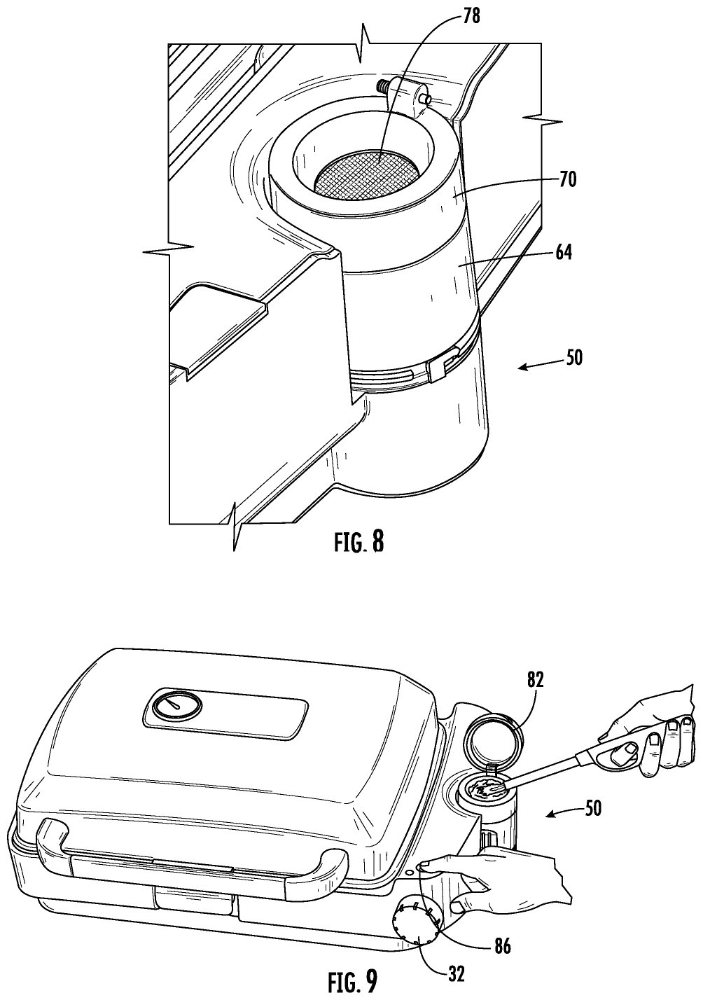

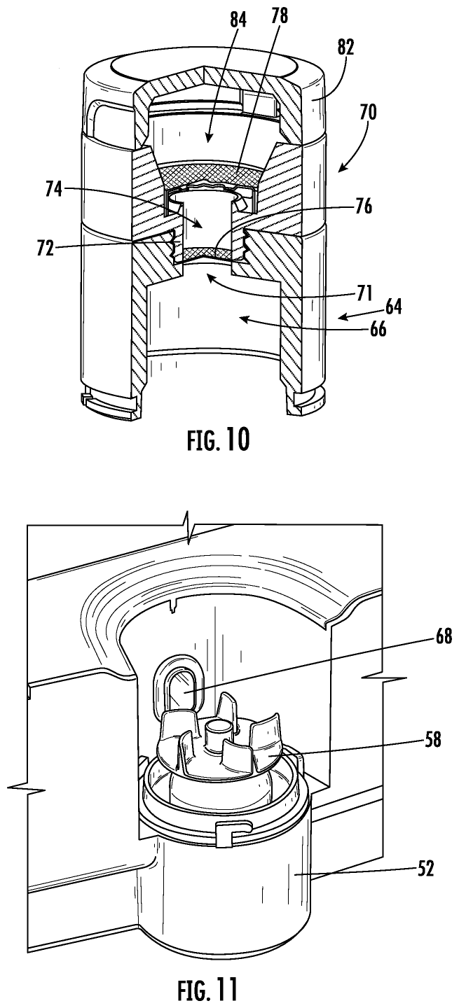

Referring now to the drawings, a flavor-infusing grill, designated broadly at 20, is shown in FIGS. 1-11. The grill 20 includes a lower housing 22 and a lid 24 that are pivotally connected at the rear by two hinges 26. The front surface of the lid 24 includes a handle 28 to assist with opening and closing of the lid 24. The lid 24 also includes a thermometer 30 in its upper surface that measures and displays the internal temperature of the grill 20.

The lower housing 22 includes a dial 32 on its front surface that enables a user to select the temperature of the grill 20 (in other embodiments, a different selection device, such as keypad or lever, may be employed). Also, a flavor-infusion module 50 is mounted on one side of the lower housing 22; the flavor-infusion module 50 will be described in greater detail below.

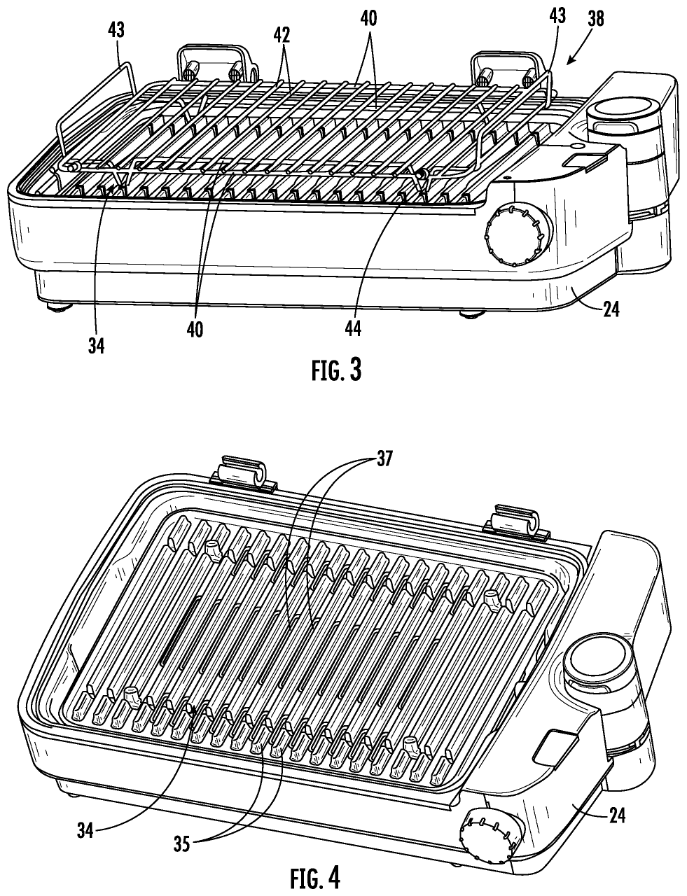

As shown in FIGS. 3-6, the lower housing 24 supports a cooking surface 34 that includes a plurality of regularly spaced transverse ribs 35. Vents 37 are located between adjacent ribs 35 in the center of the cooking surface 34; additional vents 39 are located between adjacent ribs 35 near their ends. A gasket 41 is routed near the periphery of the cooking surface 34 and provides a barrier to splatter and the like when the lid 24 is closed; while the gasket 41 provides some resistance to air flow from the cooking cavity C, typically it does not provide an airtight seal.

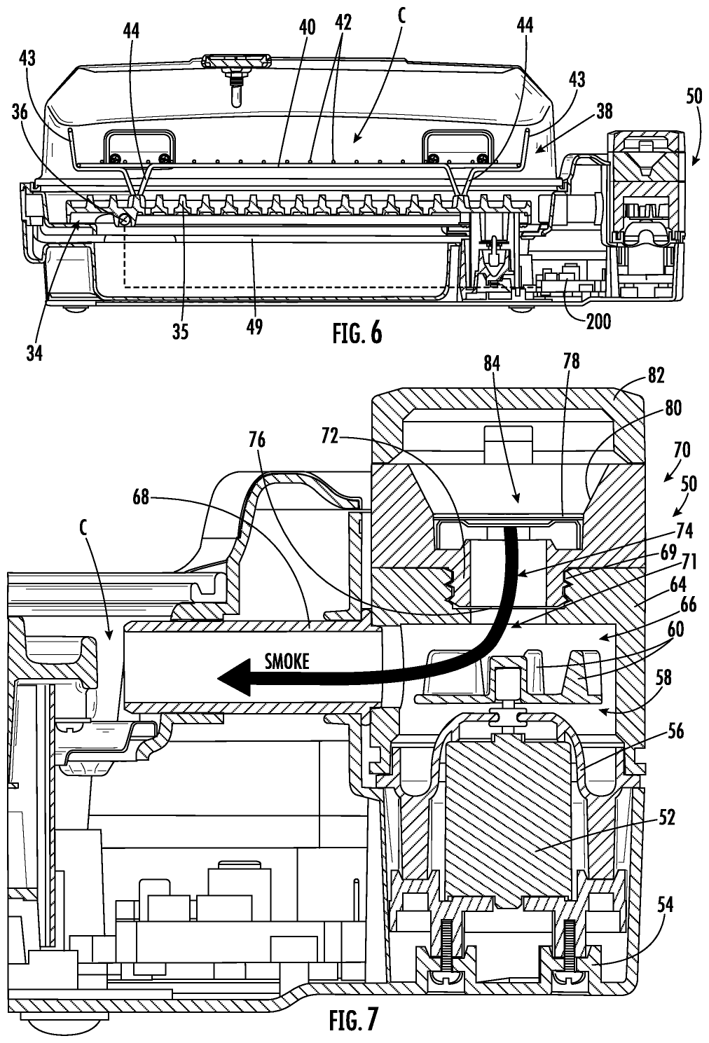

A heating element 36 is mounted directly below the cooking surface 34 to provide heat thereto. The heating element 36 is generally U-shaped and is routed between the vents 37 and the vents 39. The heating element 36 is operatively connected with a controller 200 (shown schematically in FIG. 6), the dial 32, and a power cord (not shown) that enables the user to connect the grill 20 with a standard electrical outlet. The heating element 36 may be any type of heat-generating device known to provide heat upon command.

As shown in FIGS. 3, 5B and 6, a flavor-infusion rack 38 may be present in the grill 20. The rack 38 is constructed as a skeletal frame with four longitudinal members 40 that intersect with a plurality of transverse members 42. Handles 43 extend upwardly from the sides of the rack 38. Four generally V-shaped feet 44 extend downwardly from two of the longitudinal members 40.

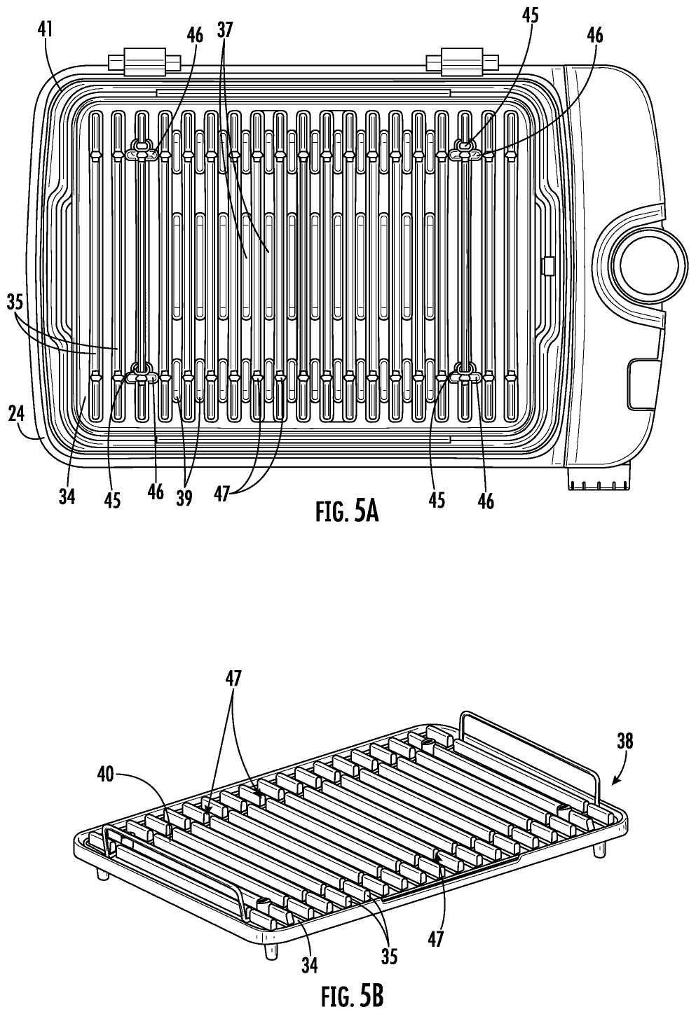

As shown in FIG. 5A, the cooking surface 34 includes four recesses 45 configured to receive lower ends of the feet 44. A slot 46 is positioned just forwardly of each of the recesses 45. Slots 47 are present in each of the ribs 35 collinear with the slots 46. This configuration enables the rack 38 to be moved between a raised position (FIGS. 3 and 6), in which the feet 44 are positioned in the recesses 45 to raise the level of the longitudinal and transverse members 40, 42 above the upper ends of the ribs 35, and a lowered position (see FIG. 5B), in which the feet 44 are received in the slots 46, the longitudinal members 40 are received in the slots 47, and the transverse members 42 are received between adjacent ribs 35.

Referring now to FIG. 6, it can be seen that a cooking cavity C is formed between the cooking surface 34 and the lower surface of the lid 24 when the lid is closed. FIG. 6 also illustrates a drain panel 49 that underlies the heating element 36 and allows fluids and juices produced during cooking to be collected; fluids can drain through the vents 37, 39 and onto the drain panel 49, which then conveys the drained fluids to a collection area on the side of the grill 20.

Referring now to FIGS. 7-11, the flavor-infusion module 50 will now be described. The module 50 includes a motor 52 with a mount 54 and a housing 56. The motor 52 is attached to a fan 58 with blades 60 via a shaft 60 and bushing 62. A blower housing 64 is mounted atop the motor housing 56 and includes an internal blower chamber 66 in which the fan 58 resides. A smoke conduit 68 is attached to one side of the blower housing 64 and is fluidly connected with both the blower chamber 66 and the cooking cavity C of the grill 10. At its upper end, the blower housing 64 has a threaded recess 69 with a bore 71. A smoke generation housing 70 is mounted to the blower housing 64 via a threaded boss 72 that mates with the threaded recess 69. The boss 72 has an internal bore 74 that aligns with the bore 70. A fine filter 76 is captured between the lower surface of the boss 72 and the lower surface of the recess 68. The smoke generation housing 70 has a second filter 78 (typically coarser than the filter 76) that is positioned at the lower end of a frustoconical opening 80. A cover 82 is hinged to the smoke generation housing 70 and is movable to cover or provide access to the opening 80. Together the smoke generation housing 70 and the cover 82 define a smoke generation chamber 84, which is in fluid communication with the blower chamber 66 via the bores 74, 71.

Referring now to FIG. 9, a push button 86 is included on the upper surface of the lower housing 22 near the dial 32. The push button 86 is operatively connected to the motor 52, such that depression of the push button 86 causes the motor 52 to rotate the fan 58 within the blower chamber 66.

When a flavor-infusing material is placed into the smoke generation chamber 84 and ignited (FIG. 9), it produces smoke. Depressing the push button 86 causes the fan 58 to rotate, which draws air and smoke from the smoke generation chamber 84 through the bores 74, 71 and into the blower chamber, then redirects the air/smoke mixture to the smoke conduit 68. The air/smoke mixture travels through the smoke conduit 68 into the cooking cavity C, where it mixes with air already therein. The presence of the smoke can infuse food positioned in the cooking cavity C with flavor. (Operation of the fan 58 may also help to ignite the flavor-infusing material).

Flavor-infusing material may be any that is known to impart a desirable flavor to foods. For example, wood chips from mesquite, hickory, applewood, or cedar trees are used. Exemplary foods suitable for infusion include meats (beef, chicken, pork, fish), vegetables, fruits and the like.

Those of skill in this art will appreciate that the grill 10 may take other forms. For example, the infusion rack 38 may be configured differently, and/or may be moved between the raised (infusion) position and the lowered (searing) position by different means (e.g., via a simple automated lifting/lowering mechanism). The cooking surface 34 may have a different configuration (e.g., the ribs 35 may be oriented perpendicularly to the manner shown, such that juices from the food drain toward the front or rear of the grill 10). The lid 24 may be attached differently (e.g., hinged on one side rather than in the rear), or in some embodiments may even be detachable. Also, in some embodiments the lid 24 may include a cooking surface that may contact the upper surface of the food. The grill 10 may operate with a different type of power source (e.g., a battery rather than a power cord and electrical outlet). Other variations may also be suitable for the grill 10.

In some embodiments, it may be desirable to operatively connect the controller 200 with the thermometer 30 and/or another temperature probe to monitor the temperature of the cooking cavity C, the cooking surface 34, the internal temperature of the food, or any combination of these. As an example, a temperature probe may monitor the temperature of the food and signal the controller to raise the temperature of the cooking surface 34 to its searing temperature once a threshold internal food temperature is reached during flavor infusion. The grill 10 may also include alarms, lights and the like to indicate when certain steps are complete or are to be commenced.

In addition, the flavor-infusion module 50 may be configured differently. For example, in the illustrated embodiment the blower housing 64 and smoke generation housing 74 are separate components (which can facilitate cleaning), but in other embodiments they may be formed as a single component. Also, the filters 76, 78 may be either integrally formed with or separate from the blower housing 64 and the smoke generation housing 74. As another alternative, the cover 82 may be detachable from the smoke generation housing 74. As a further alternative, the flavor-infusion module 50 may be attached to the lid 24 rather than to the housing 22. Other variations may also be suitable for the flavor-infusion module 50.

Further, in some embodiments the flavor-infusion module 50 may be operated automatically or semi-automatically. For example, the motor 52 for the fan 58 may be operatively connected with the controller 200, and once activated may operate for a set time period (e.g., 30 seconds) before shutting off, which can save the user the step of depressing the push button 86 to keep the fan 58 operating. As another example, an integrated heater/igniter may be employed to ignite the flavoring material in the smoke generation chamber 84. In further embodiments, the flavor-infusing material may be infused without burning.

Moreover, in some embodiments the grill 10 may include a wireless transceiver that can enable a user to control the grill 10 remotely (e.g., via Bluetooth or WiFi communications).

An exemplary infusion and cooking technique for a ribeye steak is described below:

### (a) Flavor Infusion

a. place the infusion rack 38 in the raised position of FIGS. 3 and 6;
b. with the lid 24 closed, preheat the grill 20 to 225° F. (measured by the thermometer 30);
c. open the lid 24, place a ribeye steak on the infusion rack 38, and close the lid 24;
d. place a teaspoon of flavor-infusing material (chips, pellets, fragments, etc.) into the smoke generation chamber 84;
e. using a utility lighter, ignite the flavoring material while depressing the push button 86 to operate the fan 58, and continue to depress the push button 86 for about 30 seconds;
f release the push button and close the cover 82 of the flavor-infusion module 50. The fan 58 will discontinue operation, but some smoke may still flow into the cooking cavity C;
g. repeat steps d. through f every few minutes (e.g., 4-8 minutes) until about 2 teaspoons of flavoring material are burned, or until the food reaches a target internal temperature (e.g., 124° F. for this example).

### (b) Searing

a. preheat the cooking surface 34 to a desired searing temperature;
b. open the lid 24 (most of the infusion smoke will be dissipated), move the infusion rack 38 to the lowered position of FIG. 5B, and close the lid 24;
c. sear the steak for 30-90 seconds per side to desired doneness (e.g., internal temperature of 135-140° F.).

The foregoing illustrates that the grill 10 provides the capacity to infusion foods with flavor (particularly smoky flavors) while still being used indoors.

Some embodiments of the present invention are exemplarily described above in combination with the accompanying drawings. Those of ordinary skill in the art to which the present invention belongs should understand that specific structures shown in the above embodiments are merely exemplary, rather than limiting. Moreover, those of ordinary skill in the art to which the present invention belongs can combine a variety of technical features shown above according to a variety of possible manners to constitute new technical solutions or make other modifications, and these new technical solutions are encompassed within the scope of the present invention.

That which is claimed is:

1. A grilling appliance, comprising:
a lower housing including a cooking surface;
a lid overlying and spaced from the cooking surface to define a cooking cavity;
a heating element positioned to heat the cooking surface;
a power source operatively connected with the heating element; and
a flavor-infusion module attached to at least one of the lower housing and the lid, the flavor-infusion module comprising:
a smoke generation chamber; and
a flavor-infusion conduit fluidly connected between the smoke generation chamber and the cooking cavity.

2. The grilling appliance defined in claim 1, wherein the flavor-infusion module further comprises a fan in fluid communication with the smoke generation chamber and the flavor-infusion conduit.

3. The grilling appliance defined in claim 1, wherein the flavor-infusion module further comprises a filter between the smoke generation chamber and the flavor-infusion conduit.

4. The grilling appliance defined in claim 1, wherein the flavor-infusion module further comprises a cover, the cover being movable between an access position, in which a user has access to the flavor-infusion chamber, and an operating position, in which the user has no access to the flavor-infusion chamber.

5. The grilling appliance defined in claim 1, further comprising an infusion rack within the cooking cavity, the infusion rack being configured to take a raised position in which food resting on the infusion rack is located above and not in contact with the cooking surface during infusion.

6. The grilling appliance defined in claim 5, wherein the infusion rack is configured to move to a lowered position in the cooking cavity, such that food positioned above the infusion rack is in contact with the cooking surface.

7. The grilling appliance defined in claim 1, further comprising a selection device operatively connected with the heating element for controlling heat emanated by the heating element.

8. The grilling appliance defined in claim 7, further comprising a controller operatively connected with the selection device and the heating element.

9. The grilling appliance defined in claim 1, further comprising a temperature sensor configured and positioned to detect a temperature of at least one of the cooking cavity and the cooking surface.

10. The grilling appliance defined in claim 7, further comprising a controller operatively connected with the temperature sensor and the heating element.

11. A grilling appliance, comprising:
a lower housing including a cooking surface;
a lid overlying and spaced from the cooking surface to define a cooking cavity;
a heating element positioned to heat the cooking surface;
a power source operatively connected with the heating element; and
a flavor-infusion module attached to at least one of the lower housing and the lid, the flavor-infusion module comprising:
a smoke generation chamber;
a blower chamber fluidly connected with the smoke generation chamber;
a flavor-infusion conduit fluidly connected between the blower chamber and the cooking cavity; and
a fan positioned in the blower chamber and in fluid communication with the smoke generation chamber and the flavor-infusion conduit.

12. The grilling appliance defined in claim 11, wherein the flavor-infusion module further comprises a filter between the smoke generation chamber and the flavor-infusion conduit.

13. The grilling appliance defined in claim 11, wherein the flavor-infusion module further comprises a cover, the cover being movable between an access position, in which a user has access to the flavor-infusion chamber, and an operating position, in which the user has no access to the flavor-infusion chamber.

14. The grilling appliance defined in claim 11, further comprising an infusion rack within the cooking cavity, the infusion rack being configured to take a raised position in which food resting on the infusion rack is located above and not in contact with the cooking surface during infusion.

15. The grilling appliance defined in claim 14, wherein the infusion rack is configured to move to a lowered position in the cooking cavity, such that food positioned above the infusion rack is in contact with the cooking surface.

16. The grilling appliance defined in claim 11, further comprising a selection device operatively connected with the heating element for controlling heat emanated by the heating element.

17. The grilling appliance defined in claim 16, further comprising a controller operatively connected with the selection device and the heating element.

18. The grilling appliance defined in claim 14, further comprising a temperature sensor configured and positioned to detect a temperature of at least one of the cooking cavity and the cooking surface.

19. The grilling appliance defined in claim 18, further comprising a controller operatively connected with the temperature sensor and the heating element.

20. A grilling appliance, comprising:
a lower housing including a cooking surface, the cooking surface having a plurality of upwardly-extending ribs;
a lid overlying and spaced from the cooking surface to define a cooking cavity;
a heating element positioned to heat the cooking surface;
a power source operatively connected with the heating element;
a flavor-infusion module attached to at least one of the lower housing and the lid, the flavor-infusion module comprising:
a smoke generation chamber; and
a flavor-infusion conduit fluidly connected between the smoke generation chamber and the cooking cavity; and
an infusion rack positioned within the cooking cavity, the infusion rack being configured to take a raised position above the ribs of the cooking surface so that food resting on the infusion rack is located above and not in contact with the cooking surface during infusion, the infusion rack being further configured to move to a lowered position in the cooking cavity, such that food positioned above the infusion rack is in contact with the ribs of the cooking surface and not in contact with the infusion rack.
